(19) United States
(12) Patent Application Publication
(10) Pub. No.: US 2003/0107813 A1
(43) Pub. Date: Jun. 12, 2003

(54) Reflective diffuser

(76) Inventors: Robin J T Clabburn, Wiltshire (GB); Alison M Fairhusrt, Oxfordshire (GB); David R D Tinson, Kent (GB)

Correspondence Address: Kent E Baldauf, 700 Koppers Building, 436 Seventh Avenue, Pittsburgh, PA, 15219-1818, US

(21) Appl. No.: 10/148,294

(22) PCT Filed: Nov. 29, 2000
(86) PCT No.: PCT/GB00/04539

(30) Foreign Application Priority Data
Nov. 29, 1999 (GB) 9928166.9

(51) Int. Cl. G03H 1/02; F21V 7/04; G02F 1/1335; G02B 5/28; G02B 5/02; G02B 13/20; G02B 27/00; G02B 15/14

(52) U.S. Cl. 359/599; 359/28; 359/589; 359/613; 359/702; 349/64; 362/31

(57) ABSTRACT

A light reflecting and light diffusing sheet material useful, inter alia, as a back-reflector for liquid crystal displays (LCDs), comprises a sheet of light diffusing material having a light reflecting coating or backing. In a preferred embodiment, the reflective backing comprises a light-reflecting sheet formed separately from the light-diffusing sheet and juxtaposed with a rear surface of the sheet.

THIS INVENTION relates to a light reflecting and light diffusing sheet material useful, inter alia, as a back-reflector for liquid crystal displays (LCDs).

The number and variety of hand-held devices that include liquid crystal displays (LCDs) which utilise ambient lighting to create a high brightness, high contrast colour display with a good viewing angle is increasing rapidly. Within power and cost constraints there is a trend towards the use of displays capable of ever increasing, performance including higher brightness and colour.

This application concerns two significant developments. The first is a simplified version of the light-reflecting and diffusing structure disclosed in co-pending U.K. Patent Applications Nos. 9828869.9; 9902042.2 and 9911306.0 (see below). The light-reflecting and diffusing structure disclosed in co-pending U.K. Patent Applications Nos. 9828869.9; 9902042.2 and 9911306.0 is herein referred to also, for convenience, as Lumaxis, the Trade Mark under which that structure is currently sold.

Our co-pending U.K. Patent Applications Nos. 9828869.9; 9902042.2 and 991 1306.0 disclose, inter alia, light diffusing and reflecting devices comprising an element of light-transmitting material having a surface thereof configured to form a stepped, Fresnel-type light-reflecting element, said element incorporating an array of graded refractive index structures adapted to impart light-dispersing or diffusing characteristics to the light-transmitting material and in which one surface of the material, for example the stepped surface, is coated with light-reflecting material. The light-reflective coating may be such as to reflect all light striking it and to transmit none or alternatively may be such as to transmit a proportion of the light falling on it and reflect the remainder, so that the device is partially light-transmitting and partially light-reflecting, (a quality herein referred to as “transflective”). EP-A-0294122; EPA-530269; EP-A-0801767 and EP-A-0768565 disclose techniques for the production of light diffusing sheet materials or screens in which the light diffusing effect is due to small-scale variations in refractive index and/or surface profile in the material, such variations being induced by exposure of a photopolymerisable material to polarising light through optical screens featuring a plurality of minute apertures in an opaque background or a plurality of opaque spots on a transparent background. Light diffusing sheet materials or screens of the latter type, as disclosed in these European patent specifications, are herein referred to, for convenience, as “photopolymer diffusers”.

The simpler structure proposed herein is less position-sensitive but has a lower gain than the structure disclosed in the above-noted pending applications, in the direction of “ideal diffuse reflection” which is normal to the surface of the material. The lack of position sensitivity of this simpler structure makes this product more appropriate for applications in which the user may not be in an optimum position relative to the light source.

According to one aspect of the invention there is provided a light-reflecting light diffuser comprising a sheet of light diffusing material having a light reflecting coating or backing.

In embodiments to be described herein, the light diffusing material is a generally planar sheet.

Whilst the light-reflecting coating may be, for example, a metallisation applied directly to that surface of the light diffusing sheet which is opposite that from which, in use, light enters to be reflected and diffused, and in this case may be applied, for example, by a particle deposition technique such as by vapour deposition or by sputtering, it has been found that the diffusing power of the structure is significantly enhanced if the reflective backing comprises a light-reflecting sheet formed separately from the light-diffusing, sheet and juxtaposed with a real surface of the sheet. The reflecting sheet may comprise a sheet of metal foil or a sheet of plastics foil, such as Mylar, appropriately metallised to render it reflecting, or may be a sheet which is rendered light-reflecting by any other known technique. In any event, the light-reflecting sheet or coating may be fully reflective or transflective. Tile light diffusing sheet material is preferably a photopolymer diffuser as hereinbefore defined.

The second development described in this application involves the use of reflector/transflector materials of different colours. The structures described in the above-noted pending applications were designed to be as close to a white light reflector as possible, (although the claims were not limited in scope in this respect). However, there is also a widespread interest in coloured reflectors for reasons, inter alia, of product differentiation. Apart from the colour difference, the coloured reflective materials proposed have the same benefits as the “white light” versions.

Thus, according to another aspect of the invention there is provided a light diffusing reflector comprising a sheet of light diffusing material having, on one side, a light-reflecting coating or layer which is wavelength-selective, that is to say, a coating or layer in which the reflecting, layer imparts a coloration to the light reflected therefrom by reflecting only a proportion of the wavelengths of the visible spectrum or reflecting light of some wavelengths more strongly than others.

Embodiments of the invention are described below by reference to the accompanying drawings, in which:

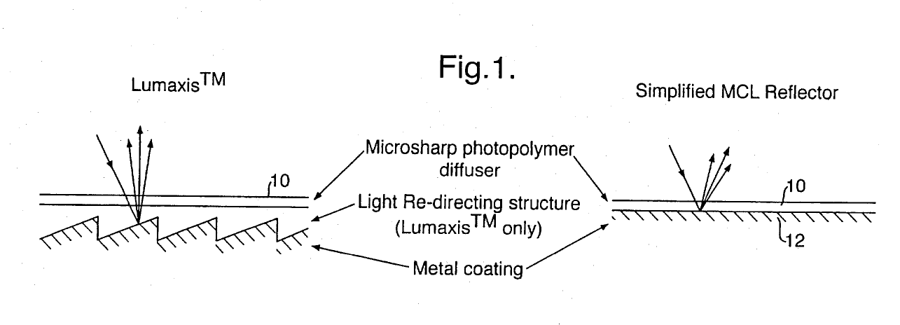

FIG. 1 is a schematic sectional view illustrating, on the left, a diffusing reflector as disclosed in co-pending U.K. Patent Applications 9828869.9 and 9902042.2 and, on the right, a diffusing reflector embodying the present invention, in one aspect,

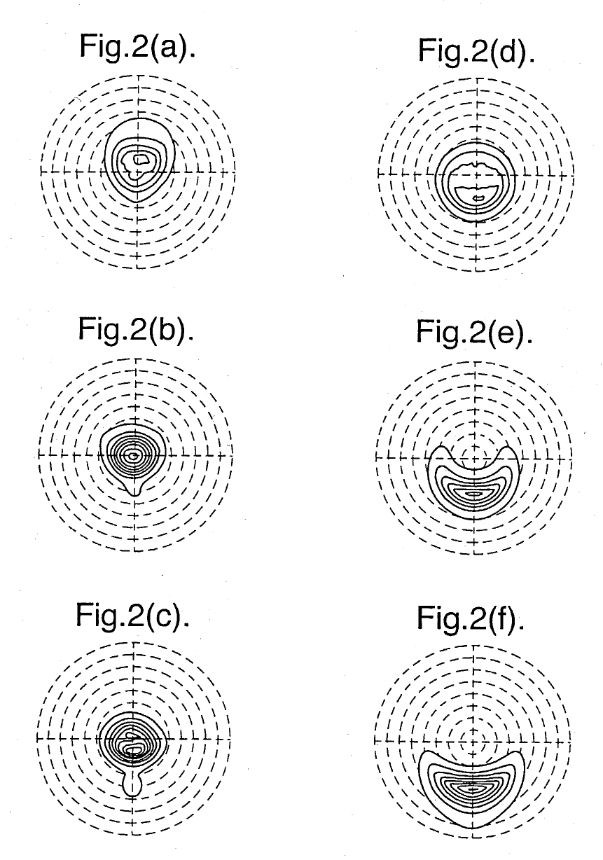

FIGS. 2(a) to 2(f) are respective polar gain plots illustrating the performance of X various light-diffusing reflectors, and

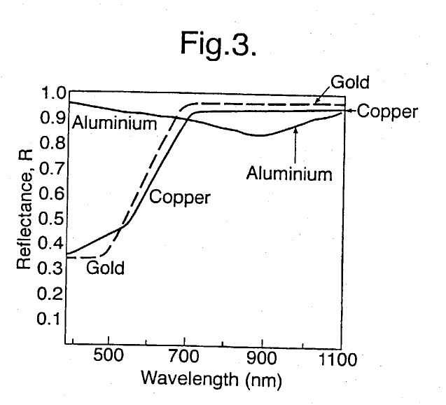

FIG. 3 is a graph showing selective spectral reflectivity of a reflective diffusive structure in accordance with the second aspect of the invention.

FIG. 1 illustrates the difference between the Lumaxis™ reflector structure referred to above and the structure of the simplified reflector product that is described in this application. The key difference between the construction of these two reflectors is that the micro-prism structure that forms a pair of Lumaxis™ is not included in the simplified design. The omission of this structure causes the reflected light from MCL's simple reflector to be specular instead of normal to the material surfaces as is true for Lumaxis™. That is to say, light directed in a parallel beam onto the reflector at an angle to the normal to the plane of the material will be reflected from the material as a spreading bundle of light rays having, (assuming no asymmetry in the light diffusing material) a symmetrical polar distribution about a vector making an equal and opposite angle to said normal.

The reflective diffuser to the right in FIG. 1 comprises a generally planar sheet 10 of light diffusing material which is preferably a photopolymer diffuser as hereinbefore defined.

Whilst the light-reflecting pair of the structure, disposed below the sheet 10 in FIG. 1, may be, for example, a metallisation applied directly to the undersurface of the light diffusing sheet 10 in FIG. 1, it has been found by the applicants that the diffusing power of the structure is significantly enhanced if the light reflecting pair of the structure comprises a light reflecting sheet 12 formed separately from the light-diffusing sheet and juxtaposed with a lower surface (in FIG. 1) of the sheets. The reflecting sheet 12 may comprise a sheet of metal foil or a sheet of plastics foil, such as Mylar, appropriately metallised to render it reflecting, or may be a sheet which is rendered light-reflecting by any other known technique. In any event, the light-reflecting sheet or coating may be fully reflective or transflective.

More detailed information about reflections from these materials is embodied in FIGS. 2(a) to 2(f) which are polar gain plots, (so-called Eldim plots), for reflections from samples of both Lumaxis™ and the simpler diffusing reflector illustrated to the right in FIG. 1. In each case there are three examples, these are the reflected light gain profiles for incident light consisting of a single narrowly collimated beam of light incident at 20°, 30° and 40°. These plots indicate that while light incident upon Lumaxis™ at a wide range of angles is reflected approximately normal to the surface of the diffuser, any specular reflections are completely suppressed, this is not true for the simple diffusing reflector represented on the right in FIG. 1. The latter reflector produces a diffused specular reflection and is therefore brightest when it is viewed from significantly off-axis angles.

Another consequence of omitting the micro-prism light re-directing structure from the simple reflector is that the overall cost of the product is reduced.

Considering now coloured reflecting diffusers in accordance with he invention, the visual impact of the display contained in hand-held devices is considered important in determining consumer perception of the device. The displays included in most current mobile telephone handsets have a dull grey/green background that is due to the colours of the transflector and polariser materials. The applicants propose coloured reflector and transflector products similar to the simplified reflectors described with reference to FIGS. 1 and 2. Thus, whereas in “white light” reflectors of the kind illustrated on either the left hand or the light hand in FIG. 1. the light-reflecting metal coating may be, for example, of aluminium, and thus reflects all wavelengths of the visible spectrum with approximately the same efficiency, the coloured reflectors described below reflect only a proportion of the wavelengths of the visible spectrum. The use of these reflectors results in the display having a background colour that is different from the standard dull grey-green.

Thus, the coatings in embodiments according to this aspect may be coated using gold, aluminiun and copper. These result in the different coloured displays due to the reflectance profiles of these metals, as shown in FIG. 3.

Although the coloured diffuser materials may be fully reflective, it is also to produce transflective versions of these.

FIG. 3 is a graph illustrating the variation of reflectivity with wavelength for, respectively, gold, copper and aluminium. There are as many reflectance profiles as there are metal alloys. Various colours may be made available through the use of different metals/metal alloys. Alloy selection has a potential further benefit in that choice of backlight wavelength will enable display performance to be optimised for both ambient and “backlight-on” applications.

In the white light reflective diffusers described as well as in the coloured reflective diffusers described, the light diffusing layer 10, whether or not formed as a photopolymer diffuser as herein defined, may have asymmetrical or symmetrical light diffusing characteristics, as desired. For example, layer 10 may be arranged to diffuse light more in one direction transverse to the mean direction of propagation of the diffused light than in a perpendicular direction transverse to such mean direction of propagation. Such diffusive asymmetry may be produced, in the case of photopolymer diffusers, as described in EP 0801767 or in EP 0768565, for example. Alternatively, or additionally, the layer 10 may itself be arranged to impart a mean angular deviation to light reflected by the reflective diffuser, so that, for example, light incident upon the reflective diffuser at an angle to the normal to the major plane of the reflective diffuser will be reflected as light distributed evenly about the normal to the major plane. Thus, the diffusing layer in such a case may impart to the reflective diffuser an off-axis property similar to that imparted to the Lumaxis™ structure by the microprism structure in the latter. Such al off-axis property can be produced for example in photopolymer diffusers by arranging for the exposure of the photopolymerisable material during manufacture of the diffuser to be effected by polymerising radiation directed onto the polymerisable material at an angle to the normal, in techniques as described in EP 0768565.

1. A light-reflecting light diffuser comprising a sheet of light diffusing material having a light reflecting coating or backing.

2. A light-reflecting light diffuser as claimed in claim 1 in which the light diffusing material is a generally planar sheet.

3. A light-reflecting light diffuser as claimed in claim 1 or claim 2 in which the light-reflecting coating is a metallisation applied directly to that surface of the light diffusing sheet which is opposite that from which, in use, light enters to be reflected and diffused.

4. A light-reflecting light diffuser as claimed in claim 3 in which the light-reflecting coating is applied by a particle deposition technique, for example, by vapour deposition or by sputtering.

5. A light-reflecting light diffuser as claimed in claim 1 or claim 2, in which the reflective backing comprises a light-reflecting sheet formed separately from the light-diffusing sheet and juxtaposed with a rear surface of the sheet.

6. A light-reflecting light diffuser as claimed in claim 5 in which the reflecting sheet comprises a sheet of metal foil or a sheet of plastics foil, metallised to render it reflecting.

7. A light-reflecting light diffuser as claimed in any preceding claim, in which the light-reflecting sheet or coating is fully reflective.

8. A light-reflecting light diffuser as claimed in any of claims 1 to 6, in which the light-reflecting sheet or coating is transflective.

9. A light-reflecting light diffuser as claimed in any preceding claim in which the light diffusing sheet material is a photopolymer diffuser as hereinbefore defined.

10. A light diffusing reflector comprising a sheet of light diffusing material having, on one side, a light-reflecting coating or layer which is wavelength-selective, that is to say, a reflecting coating or layer which imparts a coloration to the light reflected therefrom by reflecting only a proportion of the wavelength is of the visible spectrum or by reflecting light of some wavelengths more strongly than others.

11. A light diffusing reflector as claimed in claim 10, in which said reflecting coating or layer is of gold.

12. A light diffusing reflector as claimed in claim 10, in which said reflecting coating or layer is of silver.

13. A light diffusing reflector as claimed in claim 10, in which said reflecting coating or layer is of chromium.

14. A light diffusing reflector as claimed in claim 10, in which said reflecting coating or layer is of copper.

15. A light diffusing reflector as claimed in claim 10, in which said reflecting coating or layer is of aluminium.

16. A light-reflecting light diffuser as claimed in any preceding claim, in which said sheet of light diffusing material has asymmetrical light diffusing characteristics.

17. A light-reflecting light diffuser as claimed in any preceding claim in which said sheet of light diffusing material is arranged to impart a mean angular deviation to light passing therethrough so that the diffuser as a whole has an off-axis property such that light incident upon the diffuser at an angle to the normal to the major plane of the sheet material can be reflected as light distributed evenly about the normal to said major plane.
